(19) United States
(12) Patent Application Publication
(10) Pub. No.: US 2026/0158984 A1
(43) Pub. Date: Jun. 11, 2026

(54) SEATBACK TRAY SYSTEM

(71) Applicant: Honda Motor Co., Ltd., Tokyo (JP)

(72) Inventors: Saul Mijael IBAVEN BUENO, Columbus, OH (US); Conner Mills, Columbus, OH (US)

(21) Appl. No.: 18/969,664

(22) Filed: Dec. 5, 2024

(51) Int. Cl. B60N 3/00

(52) U.S. Cl. CPC B60N 3/004

(57) ABSTRACT

A seatback tray system including a tray configured to be disposed on a seatback of a first seat, and which is movable along a rail system to a first position in which the tray is arranged as a tray table for an occupant of a second seat located behind the first seat, and a second position in which the tray is arranged as a footwell cover between the first seat and the second seat.

### BACKGROUND

### 1. Field of the Disclosure

The present disclosure relates to a seatback tray system and, more particularly, to a seatback tray system including a tray that is positionable, via a rail system, as a tray table and a footwell cover.

### 2. Description of Related Art

Existing seatback tray tables for vehicles are usually fixed on the seatback, and they are only able to fold up and down. Existing footwell covers have taken various approaches. One approach involves adding a foam block to the footwell to fill the space between the front and rear seat. Another system includes seat covers with extendable surfaces that cover the footwell. For existing tray tables that are integrated with the seat, the position of the tray is fixed and cannot be adjusted. In cases where the seatback tray table is an accessory, it is typically difficult to fit the tray table into the vehicle, and they are not as solid as an integrated one. Existing footwell covers are not integrated into the vehicle, but rather are accessories that are difficult to fit into the vehicle. At least one system has been disclosed that includes a tray that can be positioned as a tray table and a footwell cover. However, positioning of this system is cumbersome and imprecise.

There is a need in the art for a seatback tray system that addresses one or more of the issues noted above.

### SUMMARY OF THE INVENTION

The present disclosure is directed to seatback tray systems featuring a tray that is movable along a rail system. This tray system includes either a support leg securable to the base of the rear seat or a support arm with a locking lever. The tray system also features rollers configured to facilitate movement of the tray along the rail system, and a spring-loaded locking pin configured to secure the tray at various positions along the rail system. In addition, the present disclosure is directed to a vehicle including neighboring seatback tray systems and a bridging system configured to span the gap between trays of the neighboring seatback tray systems.

In one aspect, the present disclosure is directed to a seatback tray system including a tray configured to be disposed on a seatback of a first seat, and which is movable along a rail system to a first position in which the tray is arranged as a tray table for an occupant of a second seat located behind the first seat, and a second position in which the tray is arranged as a footwell cover between the first seat and the second seat.

In another aspect, the present disclosure is directed to a vehicle including a seatback tray system including a first seat; a second seat positioned behind the first seat; and a seatback tray system. The seatback tray system includes a rail system mounted on a back of the first seat; and a tray configured to be disposed on a seatback of the first seat, and which is movable along the rail system to a first position in which the tray is arranged as a tray table for an occupant of the second seat, and a second position in which the tray is arranged as a footwell cover between the first seat and the second seat.

In another aspect, the present disclosure is directed to a vehicle including a first front seat; a second front seat; a first rear seat positioned behind the first front seat; a second rear seat positioned behind the second front seat; a first seatback tray system disposed on a seatback of the first front seat, the first seatback tray system including a first tray positionable as a tray table and a footwell cover between the first front seat and the second front seat; and a second seatback tray system disposed on a seatback of the second front seat, the second seatback tray system including a second tray positionable as a tray table and a footwell cover between the second front seat and the second rear seat. The vehicle also includes a bridging system configured to bridge across a gap between the first tray and the second tray.

Other systems, methods, features and advantages of the disclosure will be, or will become, apparent to one of ordinary skill in the art upon examination of the following figures and detailed description. It is intended that all such additional systems, methods, features and advantages be included within this description and this summary, be within the scope of the disclosure, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like reference numerals designate corresponding parts throughout the different views.

FIG. 1 is a schematic perspective rear view of a seatback tray system;

FIG. 2 is a schematic side view of the seatback tray system in a position in which the tray forms a footwell cover;

FIG. 3 is a schematic side view of the seatback tray system in a position in which the tray is arranged as a tray table for a rear seat occupant;

FIG. 4 is a schematic perspective view of the seatback tray system in the tray table position depicted in FIG. 3;

FIG. 5 is a schematic side view of the seatback tray system locked in the footwell cover position;

FIG. 6 is a schematic perspective view of the seatback tray system locked in the footwell cover position depicted in FIG. 5;

FIG. 7 is a schematic side view of the seatback tray system folded into a stowed position against the seatback of the front seat;

FIG. 8 is a schematic perspective view of the seatback tray system folded into a stowed position against the seatback of the front seat as depicted in FIG. 7;

FIG. 9 is a schematic side view of a second embodiment of a seatback tray system, illustrating various components of the system;

FIG. 10 is another schematic side view of the second seatback tray system embodiment illustrating various additional components of the system;

FIG. 11 is a schematic side view of the system of FIG. 9 with the tray folded into a stowed position;

FIG. 12 is a schematic rear view of the system of FIG. 9.

FIG. 13 is a schematic perspective view of a portion of a rail system of the system of FIG. 9, particularly illustrating a spring-loaded locking pin;

FIG. 14 is a schematic overhead view of a vehicle interior showing a seatback tray system featuring a hingedly attached bridging panel that is positionable between trays of neighboring seatback tray systems, shown with the bridging panel being stowed;

FIG. 15 is a schematic overhead view of the system of FIG. 14 shown with the bridging panel deployed across the gap between trays of neighboring seatback tray systems;

FIG. 16 is a schematic overhead view of a vehicle interior showing a seatback tray system featuring a pair of hingedly attached bridging panels that are positionable between trays of neighboring seatback tray systems, shown with the bridging panels being stowed;

FIG. 17 is a schematic overhead view of the system of FIG. 16 shown with the bridging panels deployed across the gap between trays of neighboring seatback tray systems;

FIG. 18 is a schematic overhead view of a vehicle interior showing a seatback tray system featuring a removable bridging panel that is positionable between trays of neighboring seatback tray systems, with the bridging panel removed; and

FIG. 19 is a schematic overhead view of the system of FIG. 18 shown with the bridging panel in place across the gap between trays of neighboring seatback tray systems.

### DETAILED DESCRIPTION

According to some aspects, the present disclosure is directed to a seatback tray system including a tray configured to be disposed on a seatback of a first seat, and which is movable along a rail system to a first position in which the tray is arranged as a tray table for an occupant of a second seat located behind the first seat, and a second position in which the tray is arranged as a footwell cover between the first seat and the second seat. The tray is further configured to fold into a stowed position in which the tray is substantially flush with the seatback of the first seat.

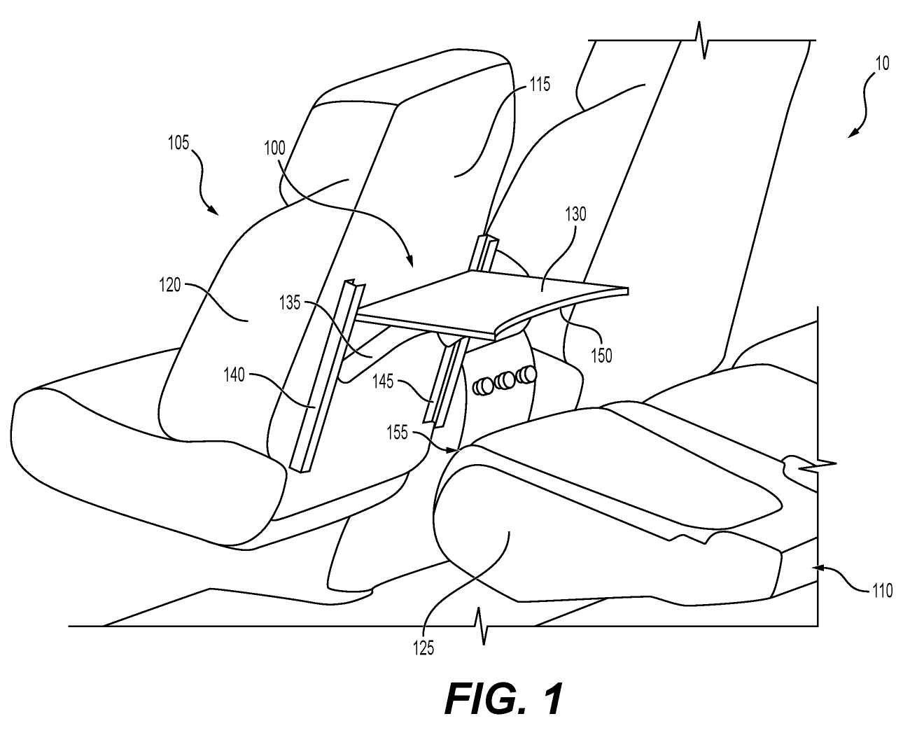

FIG. 1 is a schematic perspective rear view of a seatback tray system. The seatback tray system may be incorporated into any vehicle having seats disposed one in front of the other. Therefore, the disclosed seatback tray system may be implemented in any type of vehicle with such a seating configuration, including land vehicles, boats, airplanes, etc.

As shown in FIG. 1, the interior of a vehicle 10 includes a seatback tray system 100, which may be disposed on a first seat 105 of vehicle 10 positioned in front of a second seat 110 of vehicle 10. In particular, tray system 100 is disposed on a rear surface 115 of a seatback 120 of first seat 105. Tray system 100 is configured to be disposed between seatback 120 of first seat 105 and a seat bottom 125 of second seat 110. It will be noted that the seatback of second seat 110 is omitted from FIG. 1 in order to expose tray system 100 clearly.

As also shown in FIG. 1, tray system 100 includes a tray 130. Tray 130 may be formed of a substantially rigid material, such as plastic, wood, composite, metal, or other suitable material. System 100 further includes at least one support leg 135. As discussed in further detail below, support leg 135 may be pivotally attached to tray 130 and may be arranged with a distal end of support leg 135 on the floor of the vehicle or secured to second seat 110. Tray 130 and support leg 135 are slidable along a rail system including a first rail 140 and a second rail 145.

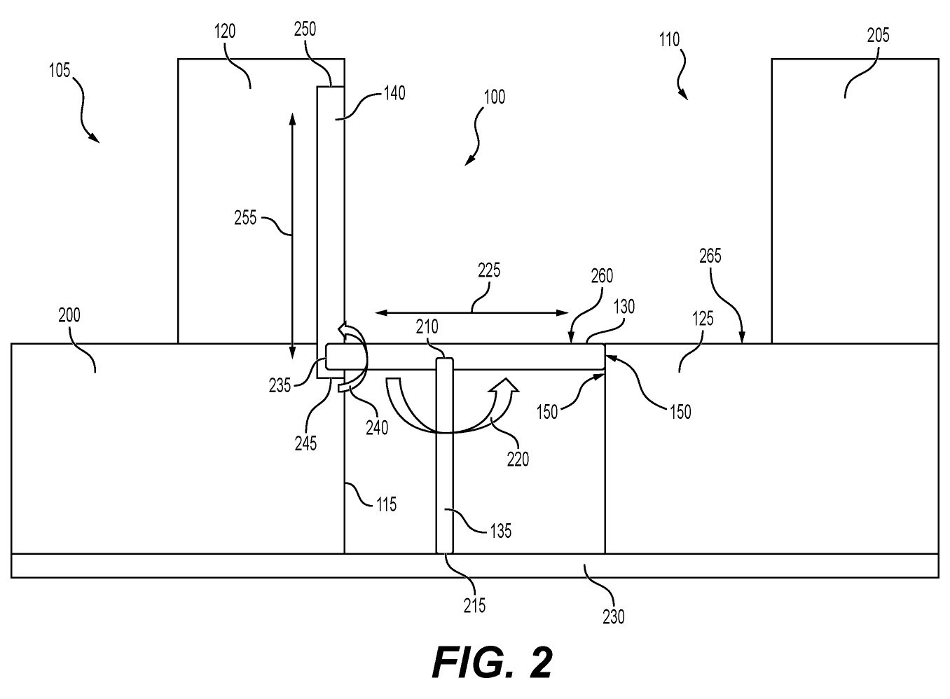

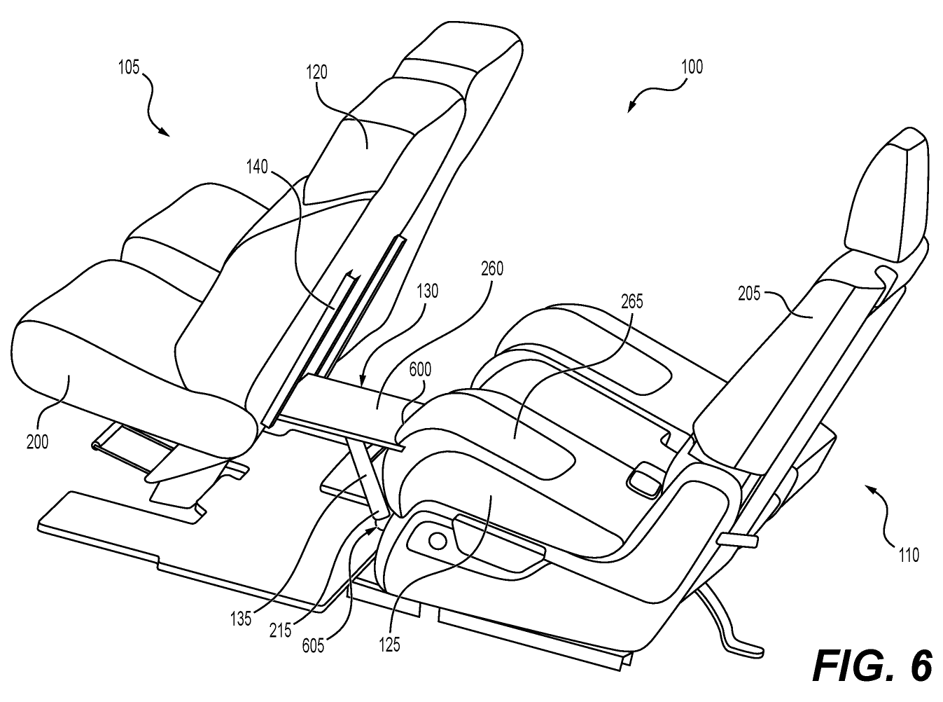

As further shown in FIG. 1, tray 130 may have a concavely curved edge 150 configured to mate with a convexly curved front portion 155 of second seat 110 when tray 130 is in the second position arranged as a footwell cover as shown in FIG. 2 and FIG. 6.

The tray is movable along the rail system to a lower position in which the tray forms a footwell cover. That is, the tray is positioned approximately at the height of the seat bottom of the rear seat in order to prevent access to the footwell area between the front seat and the rear seat. This also provides a larger platform including the combined surfaces of the rear seat bottom and the tray of the seatback tray system. This larger platform may be usable for carrying cargo, sleeping, transportation of pets, or for any other suitable use for a large platform in a rear seat area.

FIG. 2 is a schematic side view of the seatback tray system in a position in which the tray forms a footwell cover. As shown in FIG. 2, first seat 105 includes seatback 120 and a seat bottom 200. In addition, second seat 110 includes seat bottom 125 and a seatback 205.

Support arm 135 includes a proximal end 210 pivotally and slidably attached to tray 130, and a distal end 215 opposite proximal end 210. As shown in FIG. 2, support leg 135 may be swung in the direction of an arrow 220 to an upright position. In addition, as illustrated by an arrow 225, proximal end 210 of support let 135 may be slide fore and aft along tray 130. In the upright position shown in FIG. 2, support leg 135 may be positioned with distal end 215 on a floor 230 of the vehicle in order to provide support to tray 130. In a given position such as that shown in FIG. 2, a proximal end 235 may be secured at a given position along first rail 140. Proximal end 235 may be secured to first rail 140 using any suitable mechanism. An exemplary mechanism (spring-loaded locking pins) is discussed below with respect to a different embodiment. Such a mechanism may be utilized with the embodiment shown in FIGS. 1-8.

In addition, tray 130 may be pivoted at proximal end 235 as indicated by an arrow 240. Further, first rail 140 includes a lower end 245 and an upper end 250. As shown in FIG. 2, proximal end 235 of tray 130 may be slidably movable along first rail 140 between lower end 245 and upper end 250, as indicated by an arrow 255.

In this position shown in FIG. 2, tray 130 forms a footwell cover. In this position, an upper surface 260 of tray 130 and a seating surface 265 of seat bottom 125, together, form a platform for cargo, pets, sleeping, etc.

The tray may also be positioned higher along the rail system in order to provide a tray table for rear seat occupants. That is, the tray may be positioned high enough for rear seat occupants to place their legs under the tray. When positioned as a tray table, the tray may be positioned at a suitable height for eating, writing, reading, use of a laptop, etc.

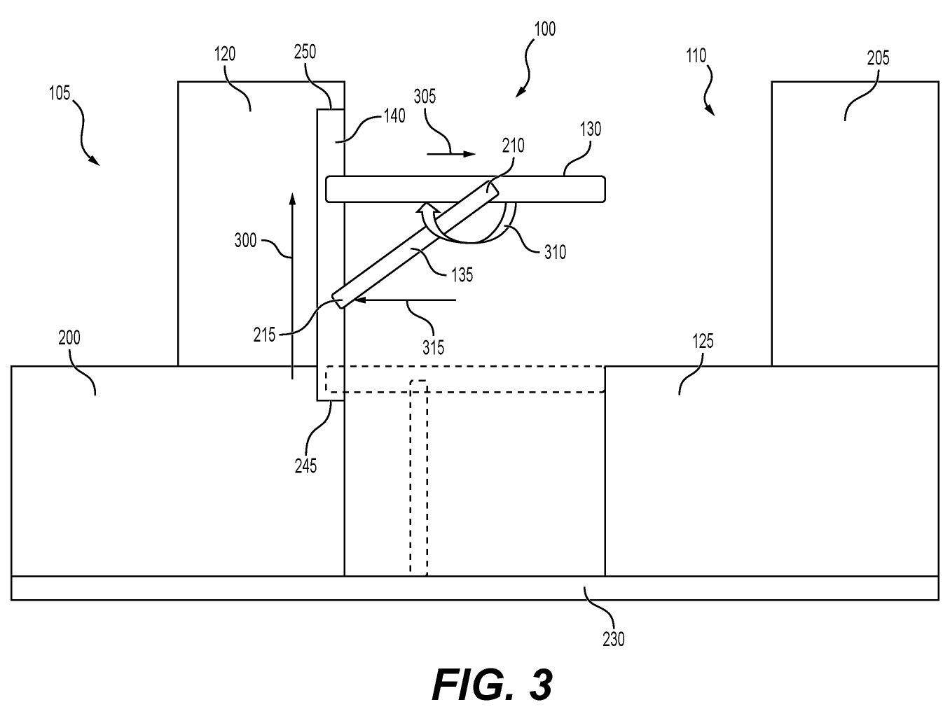

FIG. 3 is a schematic side view of the seatback tray system in a position in which the tray is arranged as a tray table for a rear seat occupant. As shown in FIG. 3, tray 130 may be slid upward along the rail system as indicated by an arrow 300. Once tray 130 is positioned at the desired height, tray 130 may be secured to the rails (e.g., with one or more spring-loaded locking pins as discussed below).

In order to position support leg 135 to secure it to first rail 140, proximal end 210 of support leg 135 is slid away from first seat 105, as shown by an arrow 310. That is, support leg may be slid fore and aft with respect to tray 130. Further, distal end 215 of support leg 135 is swung toward first seat 105, as indicated by an arrow 310. Once distal end 215 is positioned proximate first rail 140, as indicated by an arrow 315, distal end 215 may be secured to first rail 140. Any suitable mechanism may be used to secure distal end 215 to first rail 140, such as a spring-loaded locking pin, as discussed below.

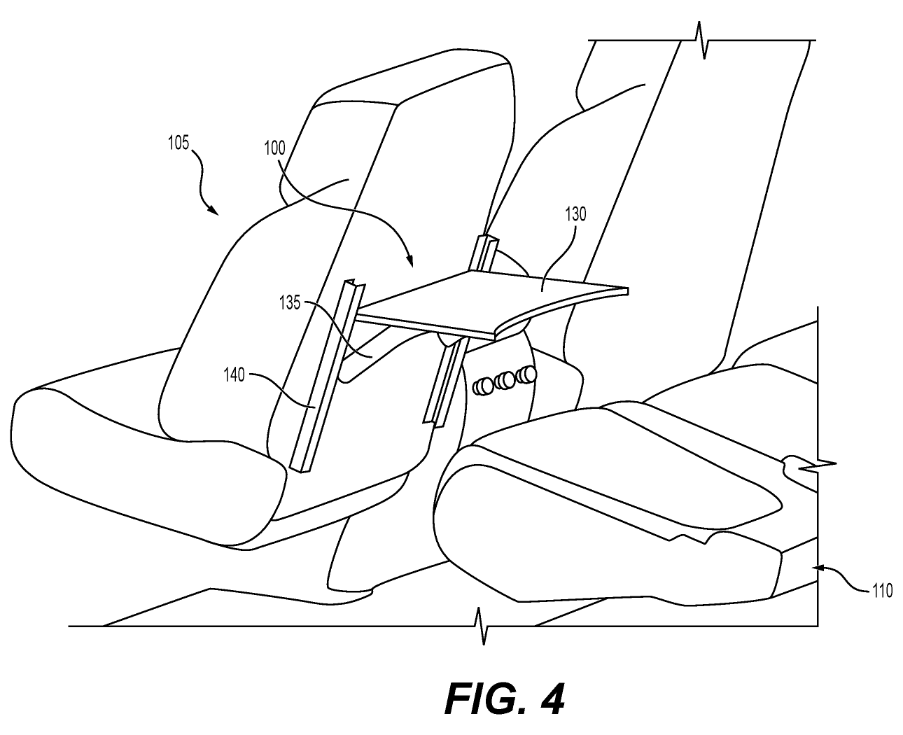

FIG. 4 is a schematic perspective view of the seatback tray system in the tray table position depicted in FIG. 3. As shown in FIG. 4, tray 130 is positioned high enough for a rear seat occupant to fit their legs under tray 130.

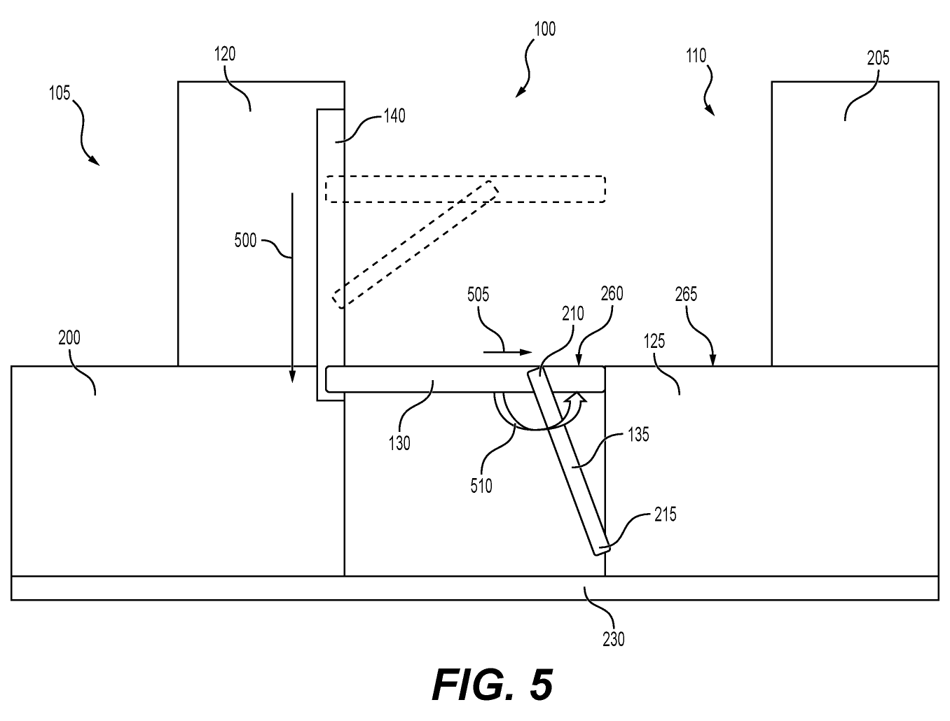

In some embodiments, the support leg may be configured to be secured to a front of the rear seat when the tray is in the second position arranged as a footwell cover. FIG. 5 is a schematic side view of the seatback tray system locked in the footwell cover position. As shown in FIG. 5, to position tray 130 into the footwell cover position, tray 130 may be slid down first rail 140, as indicated by an arrow 500. Before or after moving tray 130 downward, proximal end 210 of support leg 135 may be slid rearward along tray 130, as indicated by an arrow 505. Once proximal end 210 of support leg 135 is slid rearward, support leg 135 may be swung rearward toward second seat 110, as indicated by an arrow 510. With distal end 215 moved proximate second seat 110, distal end 215 may be secured to the front of second seat 110. This may be accomplished with any suitable mechanism to secure distal end 215 to second seat 110.

FIG. 6 is a schematic perspective view of the seatback tray system locked in the footwell cover position depicted in FIG. 5. FIG. 6 shows various features of system 100. For example, FIG. 6 shows that the rearward edge of tray 130 may mate with a front portion of second seat 110, shown at an interface 600. In addition, support leg 135 is shown, in FIG. 6, with distal end 215 secured to the front of second seat 110.

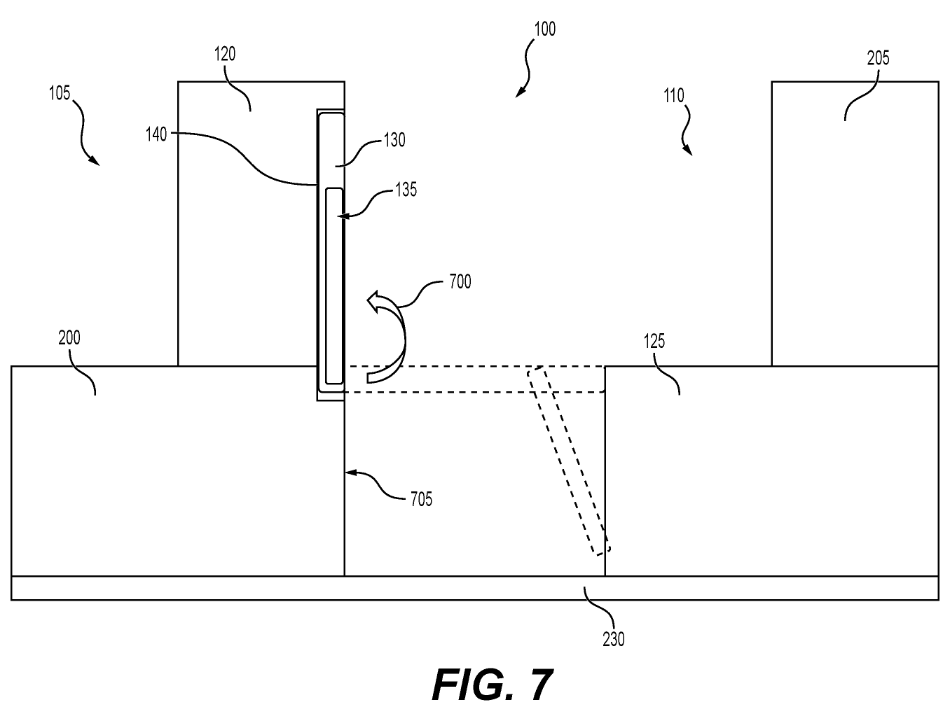

The tray is further configured to fold into a stowed position in which the tray is substantially flush with the seatback of the front seat. FIG. 7 is a schematic side view of the seatback tray system folded into a stowed position against the seatback of the front seat. As shown in FIG. 7, tray 130 may be pivoted upward, as illustrated by an arrow 700. Tray 130 may be pivoted into a stowed position in which either the top surface or bottom surface of tray 130 is flush with a rear surface 705 of first seat 105. That is, in some cases, the seat may include a recess configured to receive tray 130, such that tray 130 does not protrude from rear surface 715 when stowed.

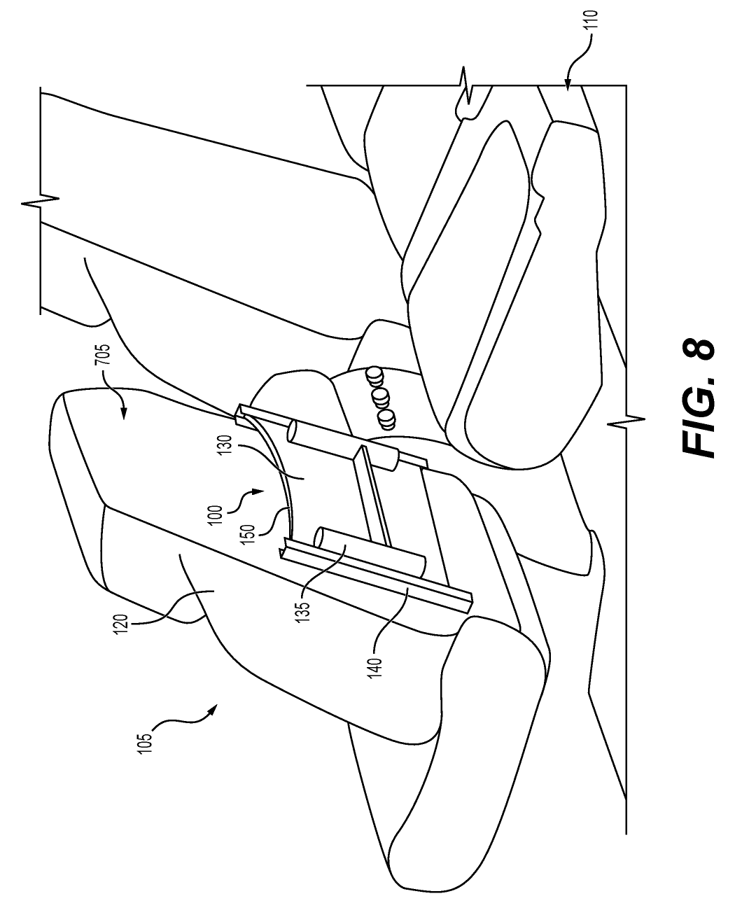

FIG. 8 is a schematic perspective view of the seatback tray system folded into a stowed position against the seatback of the front seat as depicted in FIG. 7. As shown in FIG. 8, in some embodiments, support leg 135 may be part of a stand having multiple support legs. Also well shown in FIG. 8 is the concavity of curved edge 150 of tray 130.

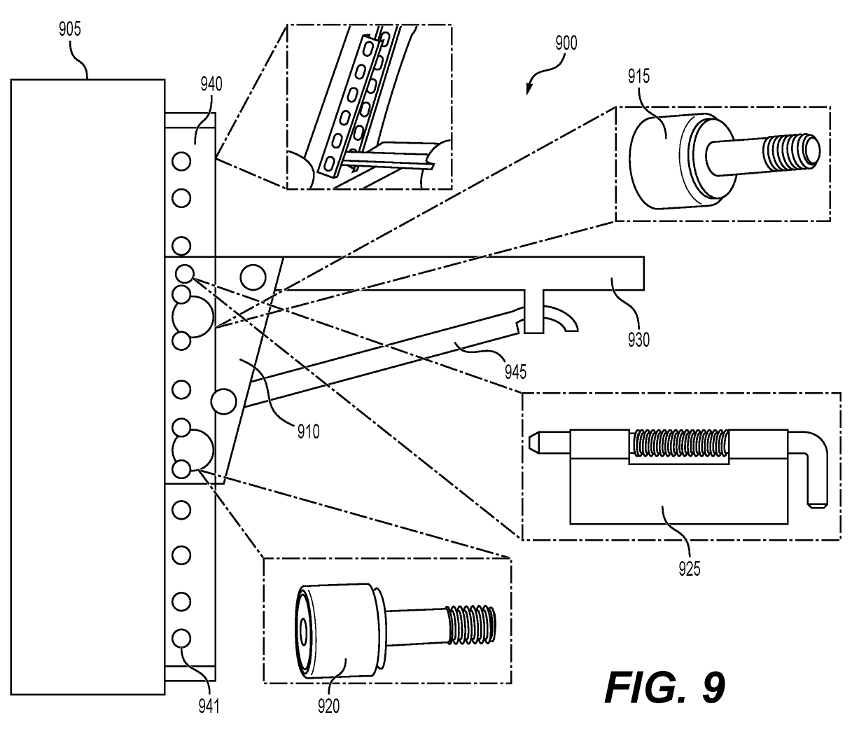

In some embodiments, the system may implement various components such as rollers for tracking in rails of the rail system, spring-loaded locking pins, and a support arm. FIG. 9 is a schematic side view of a second embodiment of a seatback tray system, illustrating various components of the system. As shown in FIG. 9, a seatback tray system 900 may be configured for mounting on a seatback of a seat 905. System 900 may include a tray 930, which may be configured substantially similarly to tray 130 discussed above.

Tray 930 may be configured to track on a rail system, including a first rail 940. The rails of the rail system have a squared C-shaped cross-sectional shape. To facilitate movement and tracking of tray 930 along the rail system, the seatback tray system 900 implements a plurality of rollers, including a first roller 915 and a second roller 920.

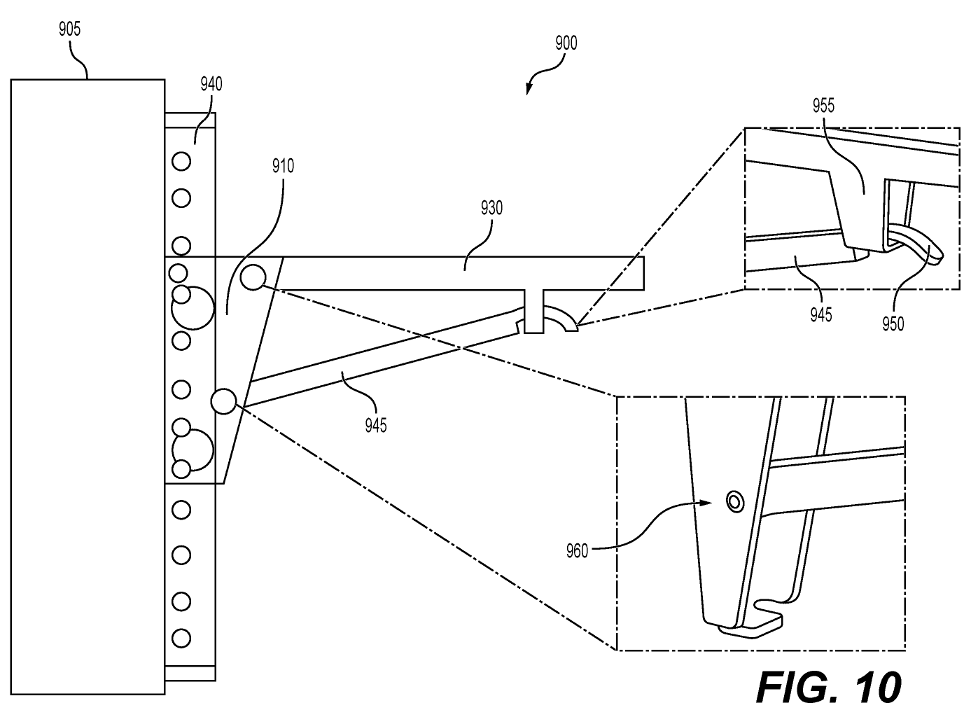

The tray system may include a support bracket slidably connected to the rail system and pivotally connected to the tray. As shown in FIG. 9, system 900 includes support bracket 910. System 900 may include a support bracket on both sides of system 900. First roller 915 and second roller 920 are screwed into support bracket 910. In addition, tray 930 is pivotally attached to support bracket 910 as discussed with respect to FIG. 10.

The tray system may also include a support arm extending from the support bracket to an underside of the tray. As shown in FIG. 9, system 900 includes a support arm 945, which is pivotally attached to support bracket 910 (see FIG. 10) and attachable to tray 930.

In addition, the tray system may include at least one spring-loaded locking pin configured to interact with a plurality of holes along the rail system in order to lock the tray at incrementally spaced positions along the rail system. As shown in FIG. 9, system 900 includes a spring-loaded locking pin 925, which may engage with a plurality of holes 941 in first rail 940.

FIG. 10 is another schematic side view of the second seatback tray system embodiment illustrating various additional components of the system. As shown in FIG. 10, tray 930 and support arm 945 are pivotally attached to support bracket 910 at pivot points 960. As also shown in FIG. 10, support arm 945 includes a release lever 950 configured to releasably lock support arm 945 to an engagement bracket 955 positioned on an underside of tray 930.

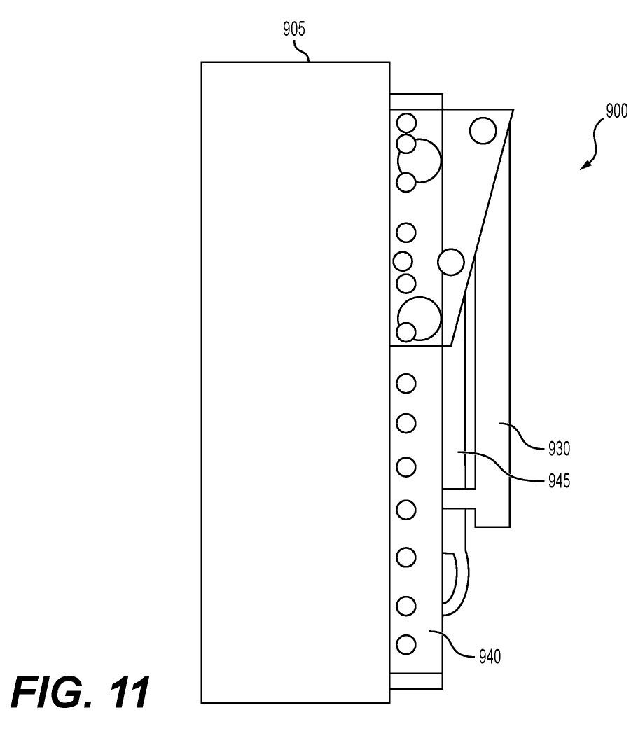

FIG. 11 is a schematic side view of the system of FIG. 9 with the tray folded into a stowed position. As shown in FIG. 11, tray 930 is pivoted downward along with support arm 945. It is noteworthy that, while the embodiment shown in FIGS. 1-8 includes a tray that folds upward, tray 930 folds downward into the stowed position.

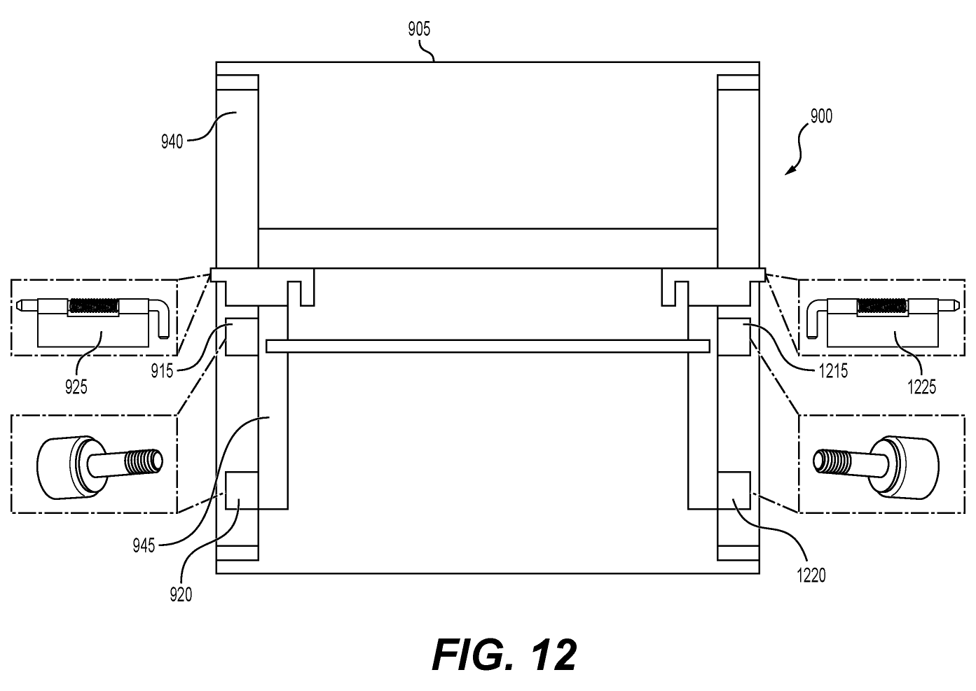

FIG. 12 is a schematic rear view of the system of FIG. 9. As shown in FIG. 12, the system includes two rails, two support brackets, and rollers and locking pins on both sides. For example, system 900 includes a third roller 1215 and a fourth roller 1220. In addition, system 900 includes a second spring-loaded locking pin 1225.

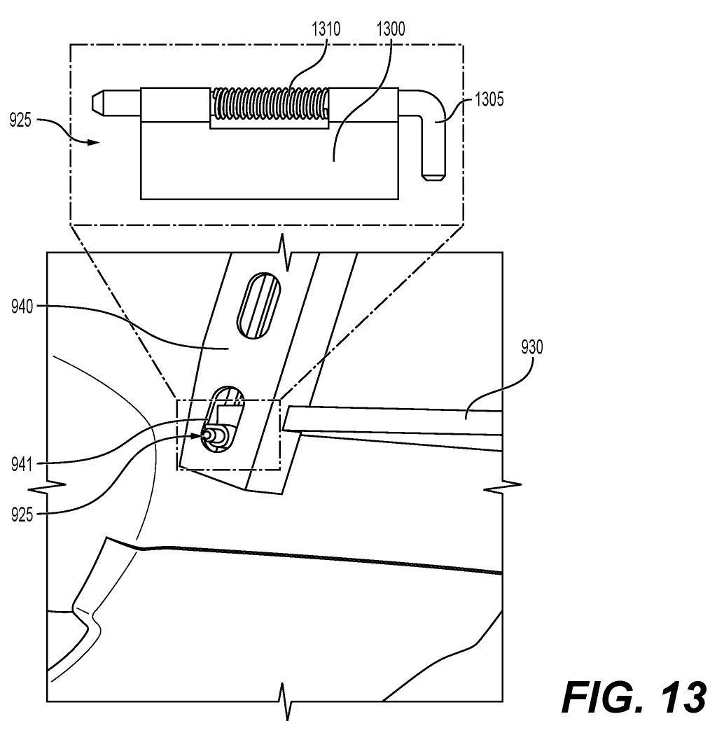

FIG. 13 is a schematic perspective view of a portion of a rail system of the system of FIG. 9, particularly illustrating a spring-loaded locking pin. As shown in FIG. 13, spring-loaded locking pin 925 includes a plate 1300, an L-shaped pin 1305, and a coil spring 1310. The L-shape of pin 1305 facilitates manual operation of the pin.

In some embodiments, a vehicle may include a bridging system including one or more panels configured to bridge across a gap between adjacent trays of neighboring seatback tray systems. For example, a vehicle may include a first front seat, a second front seat, a first rear seat positioned behind the first front seat, and a second rear seat positioned behind the second front seat. The vehicle may further include a first seatback tray system disposed on a seatback of the first front seat, the first seatback tray system including a first tray positionable as a tray table and a footwell cover between the first front seat and the second front seat. The vehicle may also include a second seatback tray system disposed on a seatback of the second front seat, the second seatback tray system including a second tray positionable as a tray table and a footwell cover between the second front seat and the second rear seat. In addition, the vehicle may include a bridge system configured to bridge across a gap between the first tray and the second tray.

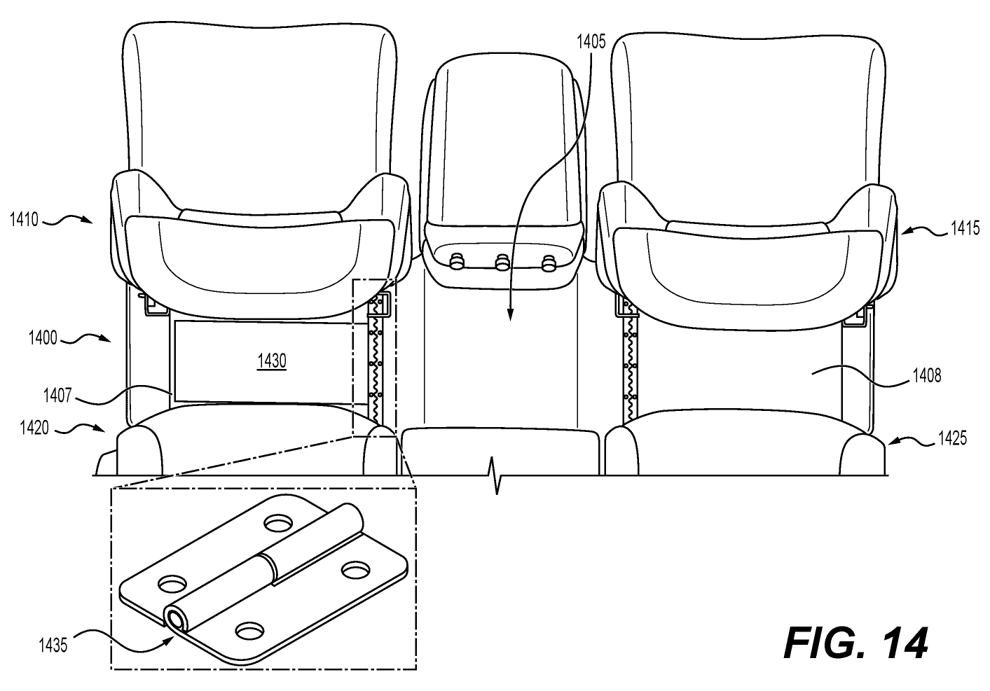

FIG. 14 is a schematic overhead view of a vehicle interior showing a seatback tray system featuring a hingedly attached bridging panel that is positionable between trays of neighboring seatback tray systems, shown with the bridging panel being stowed. As shown in FIG. 14, the vehicle includes a bridging system 1400 configured to bridge a gap 1405 between a first tray 1407 of a first seatback tray system and a second tray 1408 of a second seatback tray system. As further shown in FIG. 14, the vehicle includes a first front seat 1410 and a second front seat 1415. The vehicle also includes a first rear seat 1420 positioned behind first front seat 1410, and a second rear seat 1425 positioned behind second front seat 1415.

First tray 1407 is deployable between first front seat 1410 and first rear seat 1420. Second tray 1408 is deployable between second front seat 1415 and second rear seat 1425. Bridging system 1400 includes a bridging panel 1430 hingedly attached to first tray 1407 via a hinge 1435. It will be noted that hinge 1435 is shown generically/schematically and that the actual structure of hinge 1435 may differ slightly. For example, the proportions of hinge 1435 may vary, with the length of hinge 1435 being much longer than shown in the enlarged portion of FIG. 14.

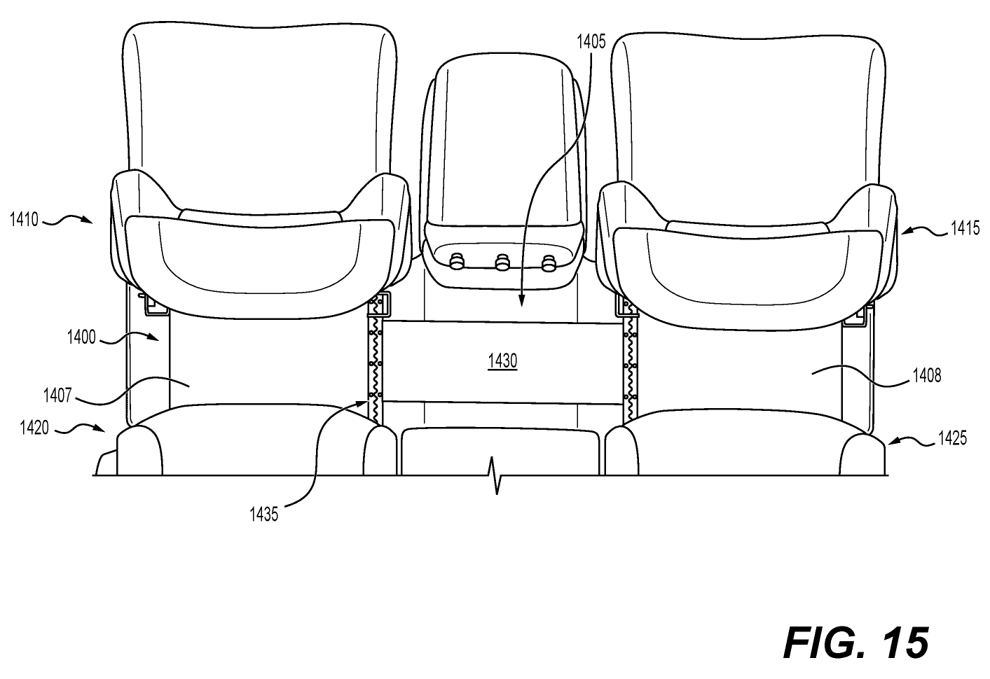

FIG. 15 is a schematic overhead view of the system of FIG. 14 shown with the bridging panel deployed across the gap between trays of neighboring seatback tray systems. In some embodiments, the bridge system may include a bridge panel hingedly attached to the first tray and pivotably movable into a bridging position across the gap between the first tray and the second tray. As shown in FIG. 15, bringing panel 1430 may be hingedly deployed into a bridging position in gap 1405 between first panel 1407 and second panel 1408 of neighboring seatback tray systems.

In some embodiments, the bridge system may include a first bridge panel hingedly attached to the first tray and pivotably movable into a bridging position across a portion of the gap between the first tray and the second tray; and a second bridge panel hingedly attached to the second tray and pivotably movable into a bridging position across a portion of the gap between the first tray and the second tray, such that the first bridge panel and the second bridge panel, together, bridge across the entire gap between the first tray and the second tray.

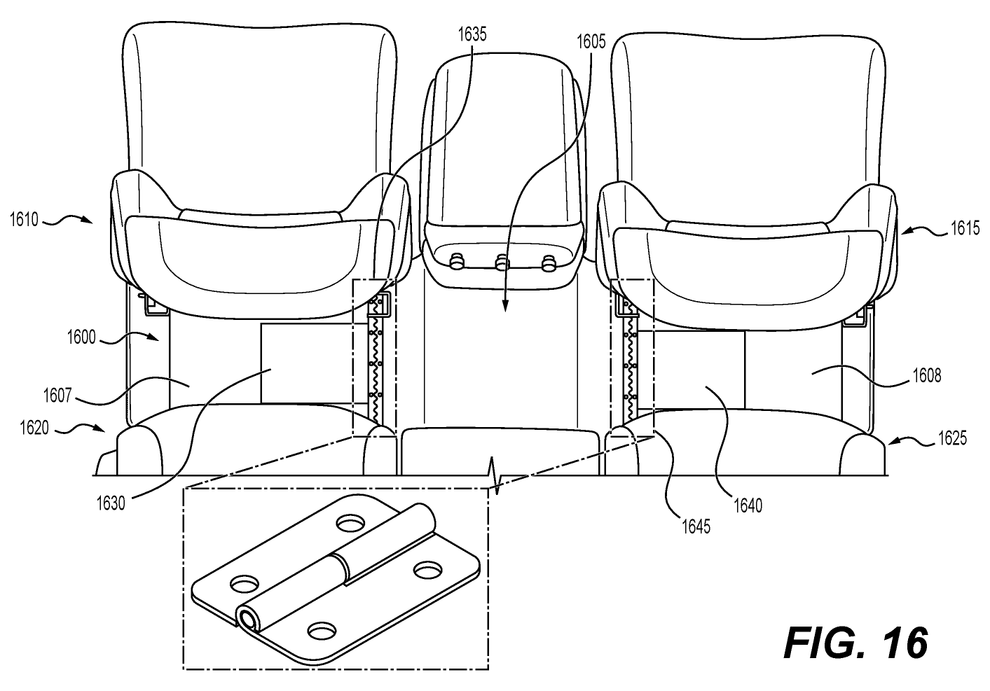

FIG. 16 is a schematic overhead view of a vehicle interior showing a seatback tray system featuring a pair of hingedly attached bridging panels that are positionable between trays of neighboring seatback tray systems, shown with the bridging panels being stowed. As shown in FIG. 16, the vehicle may include a bridging system 1600 configured to be deployed in a gap 1605 between a first tray 1607 of a first seatback tray system and a second tray 1608 of a second seatback tray system.

As shown in FIG. 16, the vehicle may include a first front seat 1610 and a second front seat 1615. In addition, the vehicle includes a first rear seat 1620 positioned behind first front seat 1610, and a second rear seat 1625 positioned behind second front seat 1615.

First tray 1607 is deployable between first front seat 1610 and first rear seat 1620. Second tray 1608 is deployable between second front seat 1615 and second rear seat 1625. Bridging system 1600 includes a first bridging panel 1630 hingedly attached to first tray 1607 via a first hinge 1635. In addition, bridging system 1600 also include a second bridging panel 1640 hingedly attached to second tray 1608 via a second hinge 1645. Again, the enlarged portion of FIG. 16 depicts a generic hinge for illustration purposes only. The actual structure of first hinge 1635 and second hinge 1645 may vary from that depicted.

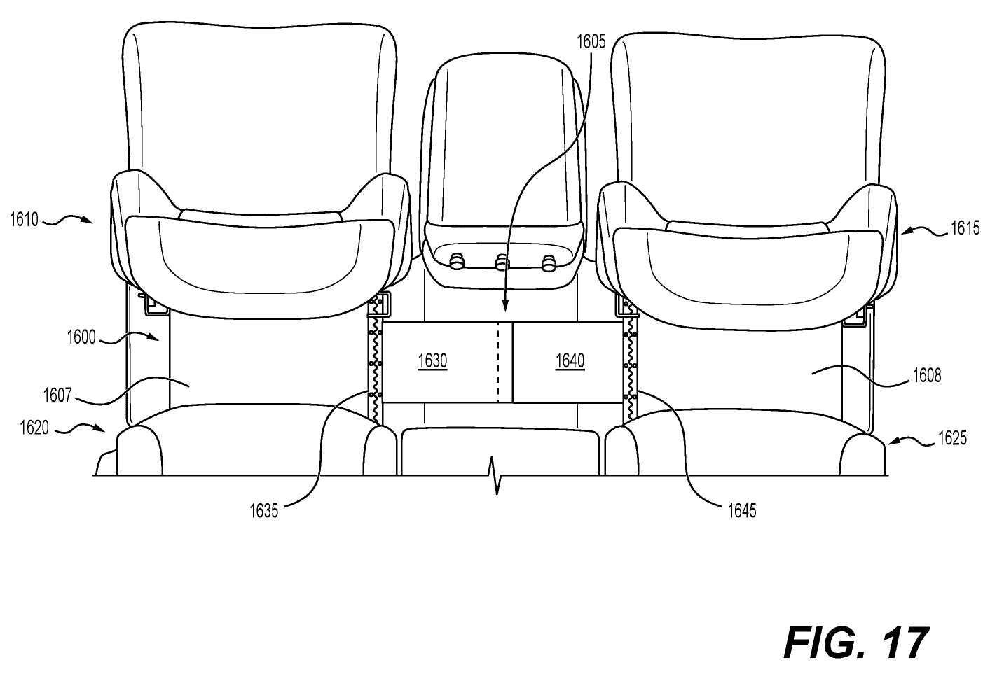

FIG. 17 is a schematic overhead view of the system of FIG. 16 shown with the bridging panels deployed across the gap between trays of neighboring seatback tray systems. As shown in FIG. 17, bringing panel 1630 may be hingedly deployed into a bridging position partially across gap 1605 between first panel 1607 and second panel 1608 of neighboring seatback tray systems. As also shown in FIG. 17, second bridging panel 1640 may be hingedly deployed into a bridging position partially across gap 1605 between first panel 1607 and second panel 1608. Together, first bridging panel 1630 and second panel 1640 may extend completely across gap 1605 or substantially completely across gap 1605.

In some embodiments, the bridging system may include a bridging panel including a plurality of protrusions arranged on an underside of the bridging panel, wherein the plurality of protrusions are configured to respectively engage with a plurality of receptacles in the first tray and the second tray; wherein, when the plurality of protrusions of the bridging panel are engaged with the plurality of receptacles of the first tray and the second tray, the bridging panel bridges across the gap between the first tray and the second tray.

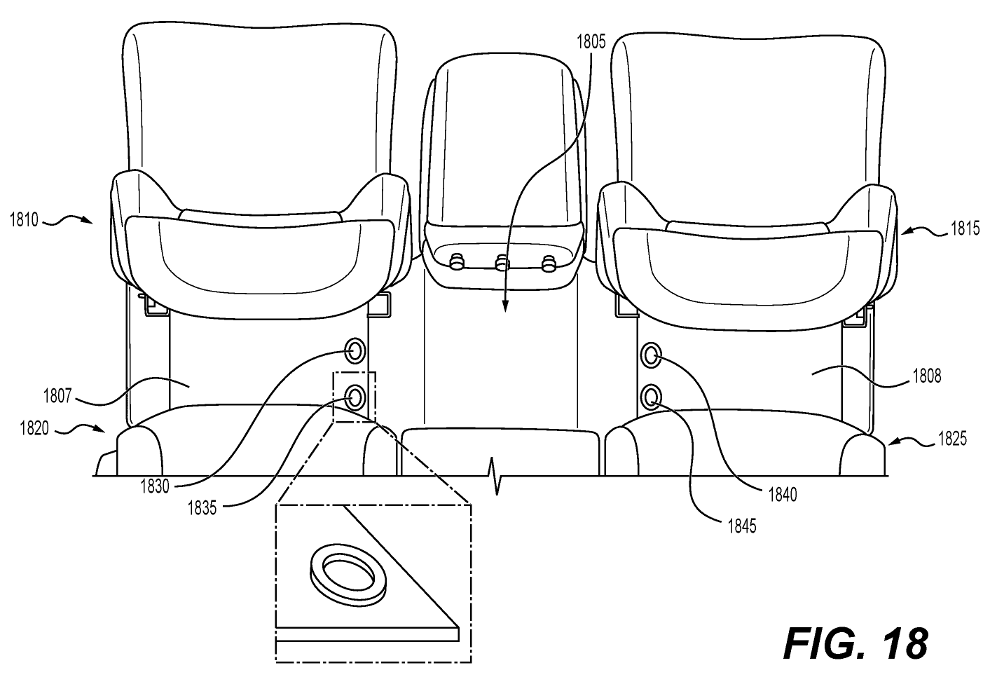

FIG. 18 is a schematic overhead view of a vehicle interior showing a seatback tray system featuring a removable bridging panel that is positionable between trays of neighboring seatback tray systems, with the bridging panel removed. As shown in FIG. 18, the vehicle may include a bridging system that include a removable bridging panel attachable in a gap 1805 between a first tray 1807 of a first seatback tray system and a second tray 1808 of a second seatback tray system.

As shown in FIG. 18, the vehicle may include a first front seat 1810 and a second front seat 1815. In addition, the vehicle includes a first rear seat 1820 positioned behind first front seat 1810, and a second rear seat 1825 positioned behind second front seat 1815.

First tray 1807 is deployable between first front seat 1810 and first rear seat 1820. Second tray 1808 is deployable between second front seat 1815 and second rear seat 1825. First tray 1807 may include a first receptacle 1830 and a second receptacle 1835. In addition, second tray 1808 may include a third receptacle 1840 and a fourth receptacle 1845.

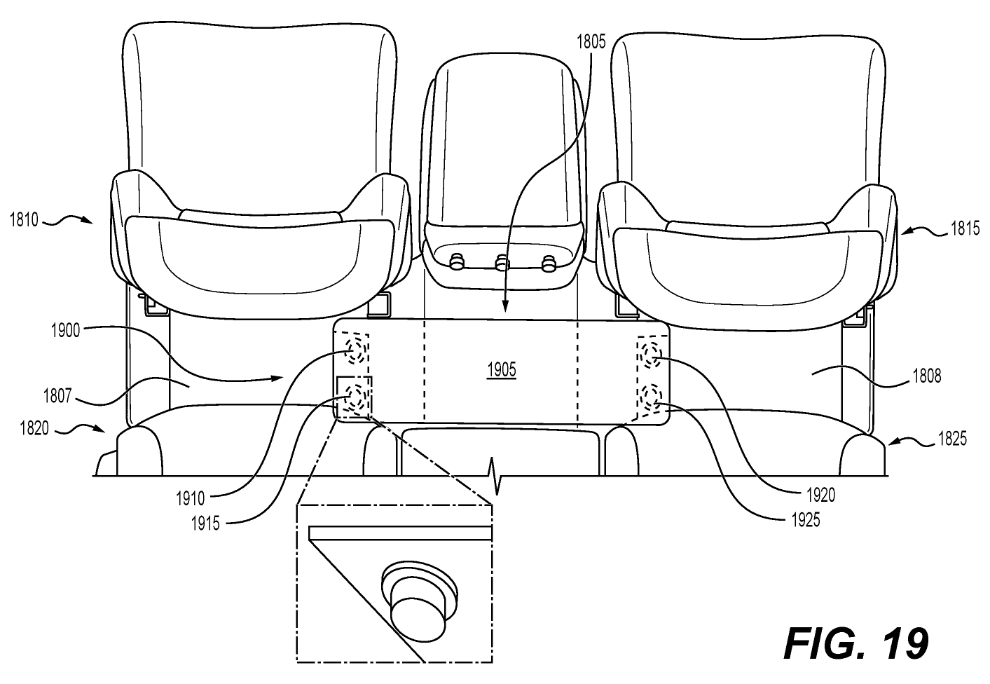

FIG. 19 is a schematic overhead view of the system of FIG. 18 shown with the bridging panel in place across the gap between trays of neighboring seatback tray systems. As shown in FIG. 19, a bridging system 1900 may include a removable bridging panel 1905, which may be positioned across gap 1805 between first tray 1807 and second tray 1808. As further shown in FIG. 19, bridging panel 1905 includes a plurality of protrusions that are engageable with the receptacles in first tray 1807 and second tray 1808. For example, a first protrusion 1910 is receivable by first receptacle 1830. Second protrusion 1915 is receivable by second receptacle 1835. Third protrusion 1920 is receivable by third receptacle 1840. And fourth protrusion 1925 is receivable by fourth receptacle 1845.

It will be understood that the precise configuration of the protrusions and receptacles may vary as well as the number of these connecting features. While four of each are shown in the figures, bridging system 1900 may include any suitable number of protrusions and mating receptacles. It will also be understood that, in some embodiments, the protrusions may be on the trays and the receptacles may be on the bridging panel.

While various embodiments have been described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with, or substituted for, any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

We claim:

1. A seatback tray system, comprising:
a tray configured to be disposed on a seatback of a first seat, and which is movable along a rail system to a first position in which the tray is arranged as a tray table for an occupant of a second seat located behind the first seat, and a second position in which the tray is arranged as a footwell cover between the first seat and the second seat.

2. The seatback tray system of claim 1, wherein the tray is further configured to fold into a stowed position in which the tray is substantially flush with the seatback of the first seat.

3. The seatback tray system of claim 1, wherein the tray has a concavely curved edge configured to mate with a convexly curved front portion of the second seat when the tray is in the second position arranged as a footwell cover.

4. The seatback tray system of claim 1, further including a support leg configured to be secured to a front of the second seat when the tray is in the second position arranged as a footwell cover.

5. The seatback tray system of claim 4, wherein the support leg is slidable fore and aft with respect to the tray.

6. The seatback tray system of claim 1, further including a plurality of rollers configured to facilitate movement of the tray along the rail system.

7. The seatback tray system of claim 1, further including at least one spring-loaded locking pin configured to interact with a plurality of holes along the rail system in order to lock the tray at incrementally spaced positions along the rail system.

8. The seatback tray system of claim 1, further including:
a support bracket slidably connected to the rail system and pivotally connected to the tray;
a support arm extending from the support bracket to an underside of the tray.

9. The seatback tray system of claim 8, wherein the support arm has a release lever configured to releasably lock the support arm to an engagement bracket positioned on an underside of the tray.

10. A vehicle, comprising:
a first seat;
a second seat positioned behind the first seat; and
a seatback tray system including:
a rail system mounted on a back of the first seat; and
a tray configured to be disposed on a seatback of the first seat, and which is movable along the rail system to a first position in which the tray is arranged as a tray table for an occupant of the second seat, and a second position in which the tray is arranged as a footwell cover between the first seat and the second seat.

11. The vehicle of claim 10, wherein the tray is further configured to fold into a stowed position in which the tray is substantially flush with the seatback of the first seat.

12. The vehicle of claim 10, wherein the tray has a concavely curved edge configured to mate with a convexly curved front portion of the second seat when the tray is in the second position arranged as a footwell cover.

13. The vehicle of claim 10, further including a support leg configured to be secured to a front of the second seat when the tray is in the second position arranged as a footwell cover.

14. The vehicle of claim 10, further including a plurality of rollers configured to facilitate movement of the tray along the rail system.

15. The vehicle of claim 10, further including at least one spring-loaded locking pin configured to interact with a plurality of holes along the rail system in order to lock the tray at incrementally spaced positions along the rail system.

16. The vehicle of claim 10, further including:
a support bracket slidably connected to the rail system and pivotally connected to the tray;
a support arm extending from the support bracket to an underside of the tray.

17. A vehicle, comprising:
a first front seat;
a second front seat;
a first rear seat positioned behind the first front seat;
a second rear seat positioned behind the second front seat;
a first seatback tray system disposed on a seatback of the first front seat, the first seatback tray system including a first tray positionable as a tray table and a footwell cover between the first front seat and the second front seat;
a second seatback tray system disposed on a seatback of the second front seat, the second seatback tray system including a second tray positionable as a tray table and a footwell cover between the second front seat and the second rear seat; and
a bridging system configured to bridge across a gap between the first tray and the second tray.

18. The vehicle of claim 17, wherein the bridging system includes a bridging panel hingedly attached to the first tray and pivotably movable into a bridging position across the gap between the first tray and the second tray.

19. The vehicle of claim 17, wherein the bridging system includes:
a first bridging panel hingedly attached to the first tray and pivotably movable into a bridging position across a portion of the gap between the first tray and the second tray; and
a second bridging panel hingedly attached to the second tray and pivotably movable into a bridging position across a portion of the gap between the first tray and the second tray, such that the first bridging panel and the second bridging panel, together, bridge across the entire gap between the first tray and the second tray.

20. The vehicle of claim 17, wherein the bridging system includes:
a bridging panel including a plurality of protrusions arranged on an underside of the bridging panel, wherein the plurality of protrusions are configured to respectively engage with a plurality of receptacles in the first tray and the second tray;
wherein, when the plurality of protrusions of the bridging panel are engaged with the plurality of receptacles of the first tray and the second tray, the bridging panel bridges across the gap between the first tray and the second tray.
